(19) United States
(12) Patent Application Publication
(10) Pub. No.: US 2006/0169335 A1
(43) Pub. Date: Aug. 3, 2006

(54) Foam generating device

(76) Inventors: Shu-Kuang Chan, Dongshih Township (TW); Kue-Chih Tseng, Sanxia Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/260,365

(22) Filed: Oct. 28, 2005

(30) Foreign Application Priority Data
Jan. 28, 2005 (TW) 94201638

(51) Int. Cl. B01F 3/04

(52) U.S. Cl. 137/606

(57) ABSTRACT

A foam generating device includes a detergent sending unit and a scale mixing unit. The detergent sending unit has a water supply motor and a pipe. The water supply motor is connected to the pipe, and the pipe is connected exteriorly a container wherein holds detergent. The scale mixing unit has a first electromagnetic valve and a second electromagnetic valve. The first electromagnetic valve and the second electromagnetic valve are installed on a pipe of the scale mixing unit. The pipe of scale mixing unit is connected to the pipe of the detergent sending unit, and the pipe of the scale mixing unit is also exteriorly connected to an air compressor. A foam generating device is constituted accordingly, which enables the mixture of highly compressed air and detergent, generating foam for vehicle, floor or door/window cleanings, with simplified structure and convenient control.

### BACKGROUND OF THE INVENTION

1. Field of the Invention

The present invention relates to a foam generating device; in particular, to a foam generating device which uses the mixture of highly compressed air and detergent to generate foams for cleaning.

2. Background of the Invention

When cleaning vehicles, floors or doors/window glasses, people use detergent to generate foam, and this generation process usually requires manual blending, which consumes not only time but manpower. Thus, prior art foam machines have been provided, and also used air compression to generate foams.

A prior art foam machine is shown in FIG. 1 and FIG. 2. The prior art discloses a foam machine 8, which includes a body 81, an air inlet valve 82, an adjusting valve 83, a material outlet valve 84, an material inlet valve 85, a safety gate 86, a pressure gauge 87, a liquid level tube 88. The foam machine is characterized in followed structures. The body 81 is an airtight barrel made of stainless steel, and at whose central top installed a guiding pipe 89 communicated with the body 81. One end of the guiding pipe 89 is installed with a connection pipe 90, and the other end is a material outlet pipe opening 91. One end of the connection pipe 90 is connected an adjusting valve 83, and the other end of the adjusting valve 83 is connected an air inlet valve 82. The other end of the air inlet valve 82 is installed with a connector 92. The guiding pipe 89 is installed with a foam generating chamber 93 and a material outlet pipe 94 deep in the bottom of the body 81. The other end of the material outlet pipe 94 extends out through the material outlet pipe opening 91 of the guiding pipe 89 and connecting to the material outlet valve 84, and the other end of the material outlet valve 84 installed a connector 95. The top of the guiding pipe 89 is installed a pressure gauge 87. The top of the body 81 as well as both sides of the guiding pipe 89 installed respectively the material inlet valve 85 and the safety gate 86. One side of the body 81 is installed a liquid level tube 88, and the other side is installed a handle 96. The bottom of the body 81 is installed wheels 97 and support legs 98. By assembling the above-mentioned components, using the air pressure machine to press air into the body 81, generating foam by mixing the pressed air and the detergent 99, and making the generated foamy detergent ejected from the body 81 by means of the pressure inside the body 81, thus can be used for cleaning operations.

However, for the foam machine of prior art mentioned above, it, on the body 81, requires to be installed with components like an air inlet valve 82, a pressure adjustment valve 83, a material outlet valve 84, a material inlet valve 85, a safety gate 86, a pressure gauge 87, a liquid level tube 88, a guiding pipe 89, a connection pipe 90, a material outlet pipe opening 91, foam generating chamber 93 and a material outlet pipe 94, which results in a complicated global structure, inconvenient assemblage and its control would be more complex, causing difficulties in productions and applications.

Accordingly, the inventor of the present invention realized the above-mentioned defects are improvable, thus specifically made researches on this issue, along with theoretical applications, and finally offered the present invention which is well-designed and able to effectively ameliorate the above-mentioned defects.

### SUMMAY OF THE INVENTION

The object of the present invention is to provide a foam generating device having simplified structure and convenient control, and also facilitating productions and applications.

To achieve the disclosed object, the present invention provides a foam generating device which comprises a detergent sending unit and a scale mixing unit. The detergent sending unit has a water supply motor and a pipe, in which the water supply motor is connected to the pipe, and the pipe is exteriorly connected to a container holding detergent. The scale mixing unit has a pipe, a first electromagnetic valve and a second electromagnetic valve. The first electromagnetic valve and the second electromagnetic valve are installed on the pipe of the scale mixing unit. The pipe of the scale mixing unit is connected to the pipe of the detergent sending unit, and the pipe of the scale mixing unit is exteriorly connected to an air compressor.

To further better understand the characteristics and technical contents of the present invention, please refer to the following detailed description and appended drawings relevant to the present invention, though the appended drawings are only for the purposes of reference and illustration, not intended to limit the present invention.

### BRIEF DESCRIPTION OF THE DRAWINGS

FIG. 1 illustrates the prospect view diagram of a prior art foam machine.

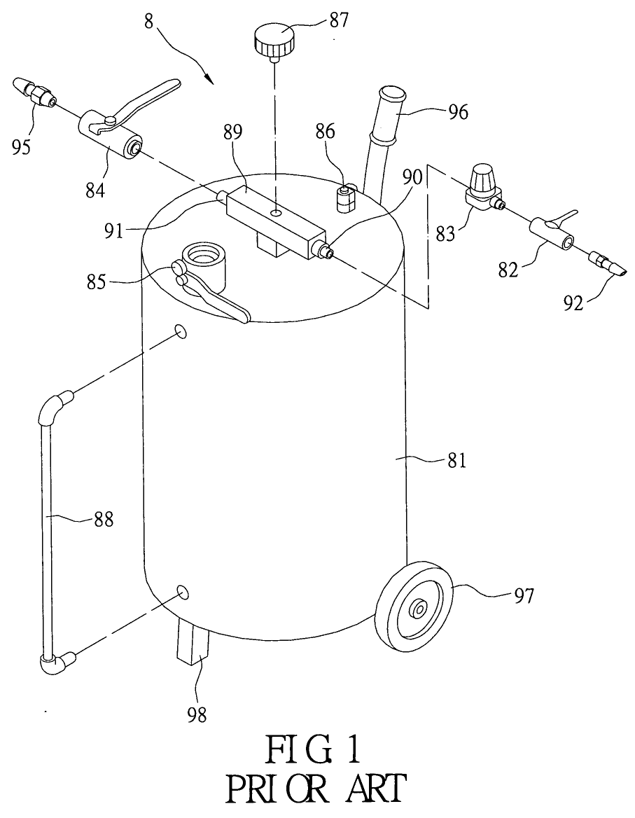

FIG. 2 illustrates the cross-sectional diagram of a prior art foam machine.

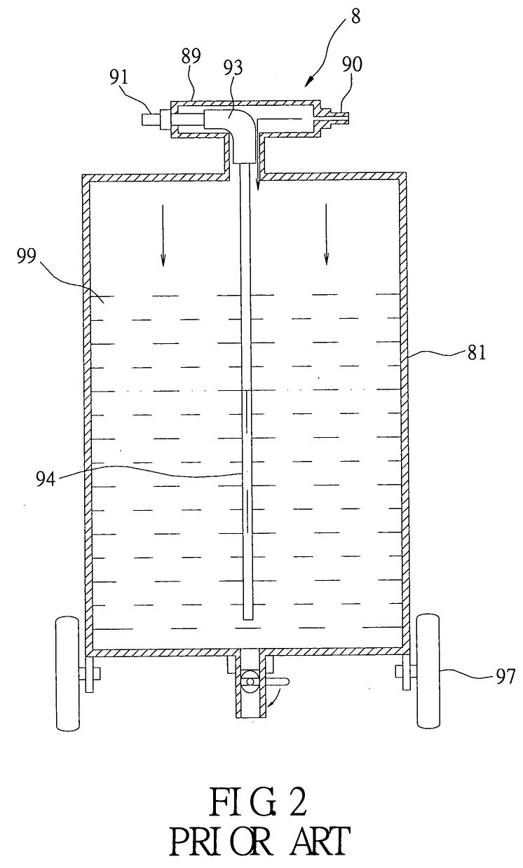

FIG. 3 illustrates the prospect view diagram of the present invention.

FIG. 4 illustrates the plan view diagram of the present invention.

FIG. 5 illustrates the loop diagram of the present invention.

### DETAILED DESCRIPTION OF PREFERRED EMBODIMENTS

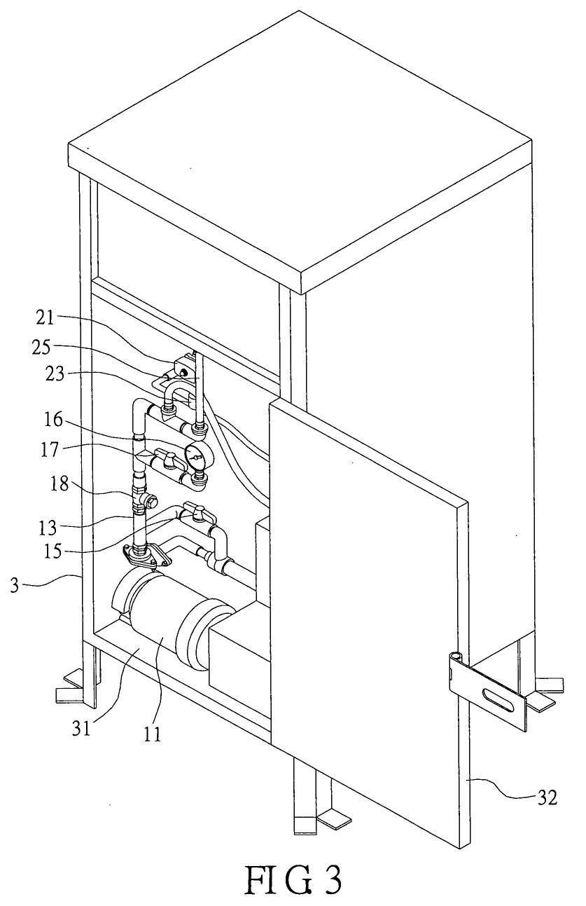

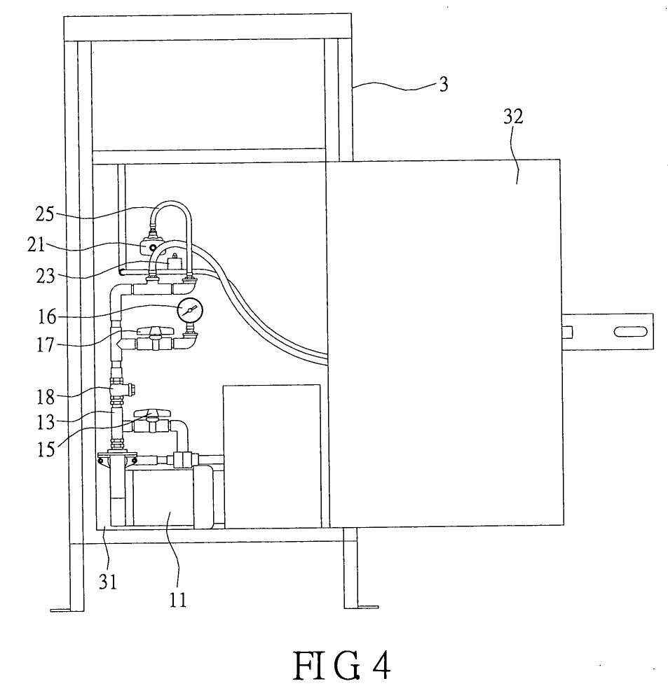

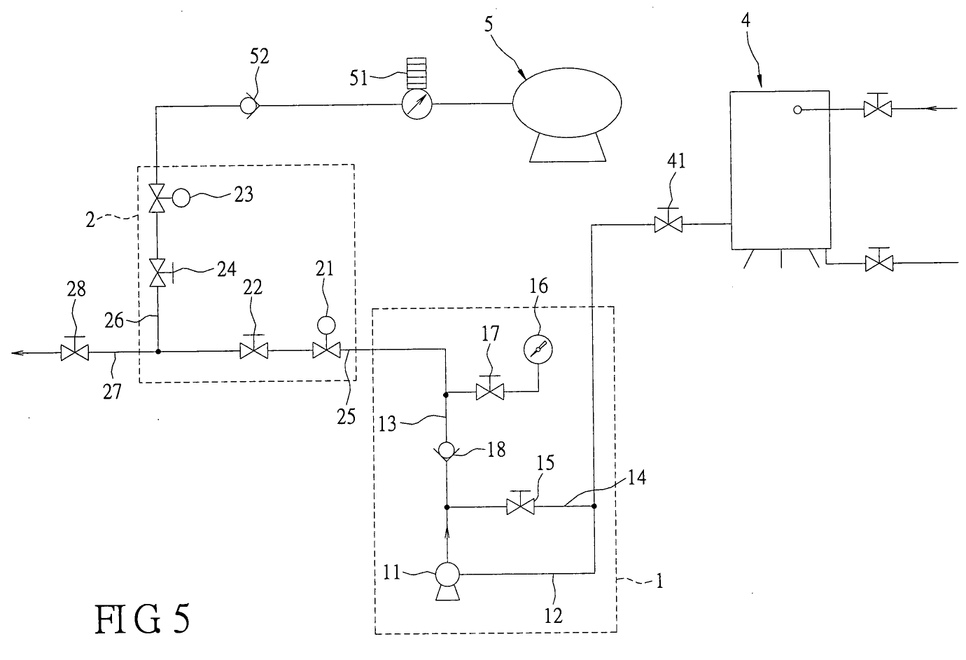

Now refer to the FIGS. 3, 4 and 5, wherein the present invention provides a foam generating device, in which comprises a detergent sending unit 1 and a scale mixing unit 2. In this embodiment, the detergent sending unit 1 and the scale mixing unit 2 are installed inside a body 3. The body 3 is a hollow shell body, where inside formed a holding space 31 for accommodating the detergent sending unit 1 and the scale mixing unit 2. The front side of the holding space 31 forms a shape of opening, and is coupled to a door pad 32 for sealing the front opening of the holding space 31.

The detergent sending unit 1 has a water supply motor 11, a first pipe 12 and a second pipe 13. One end of the first pipe 12 is connected to an input end of the water supply motor 11, and one end of the second pipe 13 is connected to an output end of the water supply motor 11. The pipes 12, 13 can be used to convey the detergent. The other end of the first pipe 12 is then exteriorly connected to a container 4 that containing the detergent. The container 4 represents a device such as a water tower, which uses appropriate pipes to conduct tap water and guides it into the container 4 for storage, and also adds water into the chemical materials to obtain the detergent. The first pipe 12 also installs with a container switch 41 that is contingent to the container 4. When the container switch 41 is on and the water supply motor 11 is enabled, the detergent held in the container 4 can be pumped out by the water supply motor 11, sequentially transferred via the first pipe 12 and the second pipe 13, and conveyed to the scale mixing unit 2.

A third pipe 14 can be also directly connected between the first pipe 12 and the second pipe 13, and a control switch 15 can be installed on the third pipe 14 to adjust pressure. A pressure gauge 16 is connected to the second pipe 13, and a pressure gauge switch 17 is installed between the pressure gauge 16 and the second pipe 13. When the pressure gauge switch 17 is on, the pressure gauge 16 can readily display the water pressure of the detergent transferred by the water supply motor 11. A check valve 18 is connected to the second pipe 13 to prevent the flow-back of the detergent.

The scale mixing unit 2 has a first electromagnetic valve 21, a first switch 22, a second electromagnetic valve 23 and a second switch 24. The first electromagnetic valve 21 and the first switch 22 are installed on a fourth pipe 25. The second electromagnetic valve 23 and the second switch 24 are installed on a fifth pipe 26. The fourth pipe 25 and the fifth pipe 26 are used to convey the detergent and high pressure air, respectively. The first electromagnetic valve 21 and the first switch 22 can be used to control the transfer of detergent. The second electromagnetic valve 23 and the second switch 24 can be used to control the transfer of high pressure air. One end of the fourth pipe 25 connects to the second pipe 13, which allows reception of the detergent conveyed from the first pipe 12, the water supply motor 11 and the second pipe 13.

One end of the fifth pipe 26 is exteriorly connected to the air compressor 5, and a pressure adjustment valve 51 and a check valve 52 are installed on the fifth pipe 26 between the second electromagnetic valve 23 and the air compressor 5. When the air compressor 5 is activated, high pressure air can be transferred to the foam sending pipe 27 through the fifth pipe 26. The pressure adjustment valve 51 and the check valve 52 are respectively used for adjusting the pressure of high pressure air emitted from the air compressor 5 and for preventing air flow-back. The other ends of the fourth pipe 25 and the fifth pipe 26 are connected to a foam sending pipe 27, on which installed a foam switch 28. By means of the above-mentioned composition, the foam generating device of the present invention can thus be constructed.

When the water supply motor 11, the first electromagnetic valve 21 and the second electromagnetic valve 23 are simultaneously activated or switched on, the detergent can sequentially be transferred to the fourth pipe 25 of the scale mixing unit 2 through the first pipe 12 of the detergent sending unit 1 and the second pipe 13. Meanwhile, the high pressure air can be transferred, via the fifth pipe 26 of the scale mixing unit 2, to a joint where intersects with the fourth pipe 25. Thus, the high pressure air can be mixed up with the detergent coming from the fourth pipe 25 to create foam. Then, by way of the foam sending pipe 27 and the foam switch 28, foam can be provided for cleaning vehicles, floors or glasses of doors and windows.

The present invention is mainly characterized in that the detergent sending unit 1 and the scale mixing unit 2 form the foam generating device, in particular the detergent sending unit 1 utilizes the water supply motor 11 to achieve the function of detergent suction, thus the structure can be significantly simplified Moreover, easier control can facilitate productions and applications. Still further, the present invention can be also constructed in a fashion of one set of detergent sending unit 1 connected to a plurality of sets of scale mixing unit 2, thus forming a plurality of sets of foam generating devices, for cleaning up more items simultaneously.

To summarize the above-mentioned disclosure, the present invention is indeed a newly invented work, which provides industrial usability, innovation and advancement, completely in compliance with the requirements of new patent application, thus hereby submitting the application in accordance with patent law for requesting thorough reviews and the granting of patent to this application, in order to protect the benefits of the inventor.

The above-mentioned disclosure, however, is merely one preferred embodiment of the present invention, rather than accordingly to limit the scope of the present invention. Therefore, it can be appreciated that all equivalent structural modifications based on the contents of the specification and appended drawings should be reasonably considered as falling within the scope of the present invention.

What is claimed is:

1. A foam generating device, comprising:
a detergent sending unit, having a water supply motor and a pipe, said water supply motor connected with said pipe, and said pipe exteriorly connected to a container, said container containing with detergent; and
a scale mixing unit, having a pipe, a first electromagnetic valve and a second electromagnetic valve, said first electromagnetic valve and said second electromagnetic valve installed on said pipe of said scale mixing unit, said pipe of the scale mixing unit connected to said pipe of said detergent sending unit, and said pipe of said scale mixing unit exteriorly connected to an air compressor.

2. The foam generating device of claim 1, wherein said pipe of said detergent sending unit comprises a first pipe and a second pipe, one end of said first pipe is connected to an input end of said water supply motor, one end of said second pipe is connected to an output end of said water supply motor, the other end of said first pipe is connected to said container, and a container switch is installed on said first pipe contingent to said container.

3. The foam generating device of claim 2, wherein a third pipe is connected between said first pipe and said second pipe, and a control switch is installed on said third pipe.

4. The foam generating device of claim 2, wherein said second pipe is connected to a check valve.

5. The foam generating device of claim 1, wherein said detergent sending unit additionally comprises a pressure gauge and a pressure gauge switch, said pressure gauge and said pressure gauge switch are connected to said pipe of said detergent sending unit.

6. The foam generating device of claim 1, wherein said scale mixing unit further comprises a first switch and a second switch, said first electromagnetic valve and said first switch are installed on a fourth pipe, said second electromagnetic valve and said second switch are installed on a fifth pipe, one end of said fourth pipe is connected to said pipe of said detergent sending unit, one end of said fifth pipe is exteriorly connected to said air compressor, the other end of said fourth pipe and said fifth pipe are connected to a foam sending pipe, and a foam switch is installed on said foam sending pipe.

7. The foam generating device of claim 6, wherein a pressure adjustment valve and a check valve are installed between said second electromagnetic valve and said air compressor.

8. The foam generating device of claim 1, further comprising a body, and a holding space is formed in said body, said detergent sending unit and said scale mixing unit are installed within said holding space.
